(19) United States
(12) Patent Application Publication
(10) Pub. No.: US 2012/0078538 A1
(43) Pub. Date: Mar. 29, 2012

(54) Precision Fluid Flow Meter for Reduced Flows

(75) Inventors: Eduardo David FRIED, Cordoba (AR); Carlos Alberto MARTIN, Cordoba (AR); Maximo Elias RAMIA, Cordoba (AR); Jorge Miguel GARNERO, Cordoba (AR)

(73) Assignee: MR TECHNOLOGIES SA, Buenos Aires (AR)

(21) Appl. No.: 13/226,201

(22) Filed: Sep. 6, 2011

(30) Foreign Application Priority Data
Sep. 6, 2010 (AR) 20100103266

(51) Int. Cl. G06F 19/00; G01F 1/56

(52) U.S. Cl. 702/46

(57) ABSTRACT

A precision meter for reduced flow which has a body housing a registry block, a block of electronics, and the transmitter sub-block of a block of communication. A receptor sub-block of the communication block is separate and allows for receiving remotely the readings obtained by the other components.

The present invention is a precision meter for reduced flows.

With the aim to make understandable the present invention so that it can be realized easily, a precise description will be given in the paragraphs that follow of a preferred form of realization. This description is completed with schematic drawings to exemplify the invention without that such description and diagrams may be considered in any limitation of the invention. The components to which a reference is made can select between various equivalents without that implicates a deviation from the principles of the invention established in the present documentation.

### STATEMENT

### Previous Art

Considering that increasing awareness is taking place related to water is a non-renewable resource and that processing and distribution of drinking fresh water involves large investments, there are an increasing number of cities in our country that incorporate the measured fluid service.

This produces that, on the one hand, the cost of the extraction, processing and distribution is distributed more equitably every time the payment is on the basis of actual consumption.

On the other hand, the fact that the cost of the service is directly linked to the rational use of the fluid and the necessary investment in conservation and maintenance of the home installation, it allows each user to take the measures necessary to ensure that the amount paid does not reflect amounts due to broken pipes, deficient faucets closing, failing stopcocks, etc.

It is not new at global level measurement of consumption, and is not necessary to move to Europe to see the use of home meters since it is enough to cross the Rio de la Plata to find that the Eastern Republic of Uruguay applied consumption measurement for more than fifty years.

Possibly the yellow fever epidemic prompted President Sarmiento to start the provision of safe drinking water and sewage services for the city of Buenos Aires, and so determined that these services where provide before in relation to the rest of the countries and it was considered that the difficulties in carrying out the measurement of individual consumption allowed to ignore it and thus equally distribute the costs among all the inhabitants.

The San Martin purification plant, located in the area of Palermo, was intended for the future and the successive expansions and modernizations led it to be the second of the world in treatment capacity, position it held until almost the end of the 20th century.

This treatment capacity and the seemingly inexhaustible water provision observed in the Uruguay, Parana and of la Plata rivers, carried that measured per capita and per day water consumption in the city of Buenos Aires exceeds the 670 liters while in the old world cities, London, for example, it was just slightly larger than 370 liters.

In the cities of the interior the story is different because it is usual that the provision of water is in the hands of cooperatives using the metered service to bill their customers.

For these cases companies suppliers of water use mechanical meters that are not appropriate to determine accurately the consumed volume.

Although the household consumption measurement is of the utmost importance, it is not the only application of the meter of low flow that is revealed.

In effect, taking into account that there are reading errors that occur when they are made on very low volumes as—as mentioned—household drinking water consumption volumes, the volumes of sprayed products to be fumigate, the volumes to include in certain mixtures, etc, and considering that in small consumptions, the register made with the meter of the prior art is inaccurate, it is considered that the proposed invention will have immediate acceptance of the companies distributors of drinking water, sprayers users and chemical industries to give only some examples.

Differences in registration obtained with meters of the prior art translates into injustices at the time to proceed to the billing or a waste (or failure of the sprayed material) or a change in the formulation, etc.

In the case where the measurement has relationship with the billing, an accurate reading as obtained with the meter proposed not only avoids any injustice but it eliminates the claim.

In these cases the costs of receiving the administrative claims from users and to give course of them, adds up to the cost of reversing the negative image that causes. This in the short term joins to the costs analysis and impacts on the State of economic performance of a company.

### DESCRIPTION

Basically, the present invention is a precision meter for reduced flow which consists of a body which houses a registry block, a block of electronics and the transmitter sub-block of a block of communication. The invention is completed with a receptor sub-block that communication block that is separated and allow receiving remotely readings obtained by the other components.

### DRAWINGS

In order to achieve a better understanding of the purpose of the present documentation it is schematized in FIG. 1 a perspective view of the magnet, coil, the yoke, polar parts and register tube.

Schematized in FIG. 2 a block diagram where are represented the three blocks that make up the meter are revealed.

In FIG. 3 it has been schematized a view in perspective of a register tube while

the FIG. 4 it has been schematized a detailed diagram of the electronic circuit and the various related components.

FIG. 5 schematizes a view in perspective of both the yoke and the magnet and finally,

FIG. 6 schematizes an exploded perspective view where the different components of the invention can be seen.

### REFERENCES

Accompanied by figures are included several references to identify the various parts and components of the invention.

In all these figures used references indicate parts or equal components.

Consequently it identifies, the number—1—a case; with the number—2—a register tube; with the number—3—an electromagnet; with the number—4—a coil; with the number—5—a yoke; with the number—6—a polar piece; with the number 7—a source of food; with the number—8—a microprocessor; with the number—9—a generator; with the number—10—a display; with the number—11—an electrode; with the number 12—a differential amplifier with the number—13—a current amplifier.

Identifies a register block with the letter—a—; an electronics block with the letter—b—and a communication block with the letter—c.

Individualizes the sign—c1—a transmitter sub-block and with the sign—c2—a receiver sub-block.

Finally letter—B—is used to indicate the magnetic flux density, and that in future we will refer simply as B, and the letter—E—for the voltage signal.

### Working Principle

Once established the various components of the invention developed to explain its nature, these are complemented with their functional and operational relationship and the result that provide.

The precision meter for reduced flows that is revealed, and that in future we will refer simply as meter, is composed of three blocks as shown in FIG. 2. Indeed, it shows a register block—a—an electronics block—b—and a communication block—c—which is subdivided in a transmitter sub-block—c1—and a receiver sub-block—c2—that is transportable and thus detachable from the rest of the meter.

In practice, the register block (a) and electronics (b) and the sub-block of transmission (c1) are arranged in the place where the reading should be done by forming a unit while the receiver sub-block (c2) is delivered to the staff responsible for carrying out the meter reading.

The unit which, as we said, is formed by the register (a) and electronics (b) blocks as well as by the transmitter (c1) subset of the communication block (c), located in a housing—1—built with a material that allows to keep the components isolated from moisture and the entry of water providing also a corrosion-free coverage.

Such building material of the casing (1) is preferably a plastic.

The register block (a) integrates with a register tube—2—interconnected into the duct of the fluid to be measured. In other words, while the present invention is aimed at the measurement of reduced flow, the pipe of fluid to be measured, for example, will be the one used for the provision of drinking water.

Such register tube (2) is built on a non-conductive material, as for example a plastic and presents one end as input and the other one as output, both of circular cross section, and in the proposed example in the preceding paragraph, provided with standard couplings connection to the water pipes of 1.27 cm (½″) either 1.91 cm (¾″) or, in any other example, with the couplings corresponding to adapt to the element whose flow must measure.

The central portion of the register tube (2) has a flattening but without that implying to modify the area of the section, which remains constant from the generation of an oblong section with two radii of curvature.

The transition from the circular cross section to the oblong section is smooth in order to avoid changes of the flow conditions of the circulating fluid, namely the internal shape of the central portion does not introduce neither charge losses nor turbulence.

In this central portion, the oblong shape provides a measuring spot with an appropriate value and homogeneity of the magnetic flux—B—.

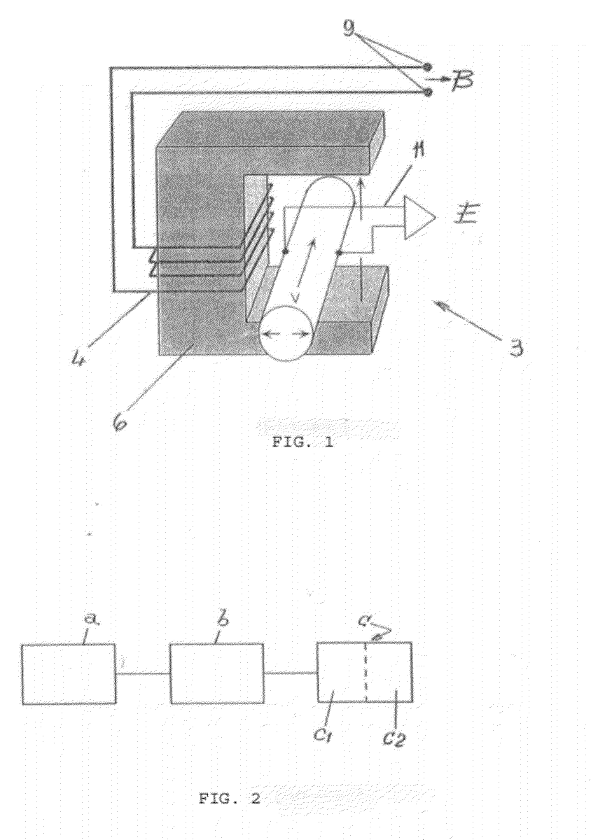

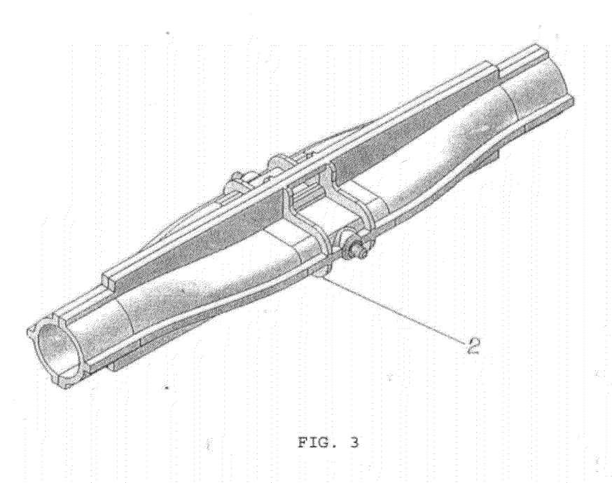

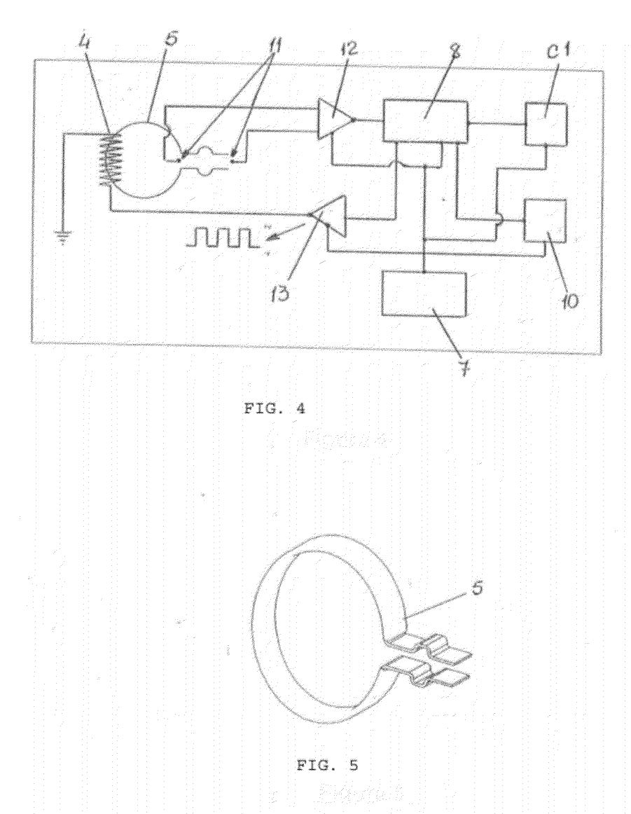

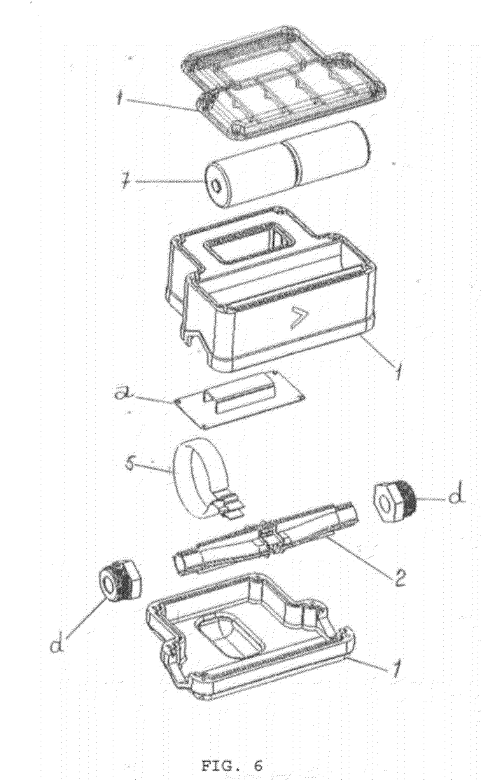

Another component of the register block (a) is the electromagnet—3—which, as seen from FIG. 5, consists of a coil—4—, a yoke—5—and the pole pieces—6—.

Considering that the meter power supply—7—in most of cases it will be a battery, this development has sought to optimize the power consumption making to that end a special design of the yoke (5) as well as the pole pieces (6).

Thus, for the design of the yoke (5) have been used a steel alloy of low magnetic permeability and it has sought to give a quasi-toroidal shape in order to decrease the loading time of the coil (4).

Thus this keeps, as high as possible, the magnitude of the magnetic flux (B) since for a torus, the magnetic flux (B) is proportional to the square of the number of winding turns, while for a straight solenoid is proportional to the number of turns.

As a result of the foregoing, the power consumption drops significantly by requiring shorter current pulses.

The pole pieces (6) are made of the same material as that used for the yoke (5) and are performed as a continuation of it for the purpose of minimizing losses by reluctance as would be if formed as separate components.

Otherwise, and to enable to reduce losses of magnetic flux (B) the geometric design of the pole pieces (6) maximizes the homogeneity of the magnetic flux (B) in the volume between these.

However, outside of this volume the losses reduction of magnetic flux lines (B) is obtained from the introduction of a curved portion in such pole pieces (6) and of a rounded form at the ends.

The second block that integrates the meter whose protection is sought is the electronic block (b) and it consists of a programmable microprocessor—8—which allows both processing and storage of the collected data and is linked to a generator—9—of magnetic flux (B) and to a display—10—which enables visualization of such data.

The measurement of the voltage signal—E—from the electrodes—11—is amplified by a differential amplifier—12—to be sent to the microprocessor (8) which digitizes, averages and stores in memory the flow data. After a predetermined time by averaging the measured flow data, the flow rate obtained is sent to the display (10) thus allowing to display a reading of the flow instantly.

Additionally, the microprocessor (8) generates a train of bipolar square pulses which are transformed into current pulses by a current amplifier—13—that feeds the coils (4) of the electromagnet (3). This in turn generates pulses of alternating magnetic flux (B).

The microprocessor (8) has a connection to the transmitter sub-block (c1) which results command and communication and allows the remote transmission, at a distance, of the accumulated data.

The data transmitted from the transmitter sub-block (c1) are received in the receiver sub-block (c2) which is held by the person collecting the meter readings and then use the control and billing of the service by the service provider.

Considering that the transmitter sub-assembly (c1) has a power that allows an efficient transmission to a distance of approximately 15 to 20 meters, the person in charge of relieving the meter readings will be enough to approach at a distance equal to or less than the above to obtain this information automatically.

This possibility of obtaining the measured data with no need to access each of the meters to personally observe their displays (10) greatly speeds up the reading assignment, especially from those installed in residential neighborhoods or in a plurality of dispensing lines or in a sprayers machinery park, etc.

Moreover, the possibility of distance readings allows locating the meters in places inaccessible to vandals and freeing such readings from accessing to where they are installed, so that it is not necessary to approach or clears the path for accessing the display readings.

Should also be considered that the independence that enables you to get distance readings obtained at any time, for example at night or low traffic or from a moving vehicle.

Both the electronic (b) and communication (c) blocks are powered from a power source (7) formed in a preferred embodiment, for long life batteries.

The remote transmission sub-block (c1) at distances of accumulated data consists of a high frequency (HF) of radio frequency (RF) transmitter receiver (transceiver) to send and receive commands and/or data to and from the microprocessor (8), while the receiver sub-set (c2) consists of a transceiver that sends and receives commands and/or data from the first named sub-set.

To facilitate taking readings, both subsets transmitter (c1) and receiver (c2) have the capacity to store commands and data.

The operator of the receiver sub-set (c2) activates the transceiver that sends an acknowledgment code to the transceiver subset of the transmitter (c1) that receives and retransmits to the microprocessor (8) that emits a signal of accepted connection.

Having established the link between the transceivers of both subsets the subset transmitter (c1) transmits the meter serial or the user number as well as all the flow data that are of interest to the provider or the person who is in charge of the control.

After that the transceiver of the transmitter sub-set (c1) sends a signal of end of transmission interrupting the link between both subsets.

The whole information received by the transceiver of the receptor sub-set (c2) is stored in its memory and emits a light signal to the operator in order to recognize that the process completed successfully.

The microprocessor (8) is programmable such that it can be configured so that all data collected by the transmitter sub-set (c1) can be selected at the convenience of those who have in charge of the control. Thus, for example, the data may be the instantaneous flow rate, the average flow, the cumulative fluid consumption, the time, the date and the serial number of the meter or the user number, etc.

All data stored in the transceiver of the receptor sub-set (c2) can then be transferred to a computer directly via a standard USB connection type so that such data can then be processed by the provider in order to use these for billing, to obtain consumer trends, investment guidelines, development, management, accounting, to change the management of measured fluids, etc.

This has been described as one of the possible sequences of steps leading to realize the invention and how it works, and the documentation is supplemented with the synthesis of the invention contained in claiming clauses that are added below.

1. Precision meter for reduced flows, the kind that is provided with a housing to contain the components, characterized because it integrates a register block, an electronics block and a communication block subdivided into a transmitter sub-block and receiver sub-block whose register block which is integrated with a tube inserted in the duct of the fluid to measure having an inlet and an outlet end section and a circular central portion with a flattening that provides a measurement area with an appropriate value and homogeneity of the magnetic flux; whose register block includes an electromagnet comprising a coil, a yoke of toroidal form and whose both pole pieces, that built as a continuation of that, have a curved portion and rounded ends; whose electronic block consists of a programmable microprocessor connected to a generator of the magnetic flux and a display to which sends the measured voltage signal from the electrodes and previously amplified by a differential amplifier; whose microprocessor generates a bipolar square pulse train converted into pulses of current through a power amplifier which supplies current to the coil of the electromagnet, in turn, generates pulses of alternating magnetic flux; whose transmitter sub-block which consists of a high frequency radio frequency transceiver linked to the microprocessor and sends the measured data to the receiver sub-block which also has a transceiver with a USB port.

2. The meter, according to claim number 1, characterized because the register tube has a section of uniform area and the flattening of the central portion does not change the cross-sectional area that remains constant due to the generation of a oblong section with two radii of curvature providing between the oblong and the circular sections a smooth transition zone which prevents affectations on the flow conditions of the circulating fluid.

3. The meter, according to claim number 1, characterized because the yoke and the pole pieces are made of an steel alloy of low magnetic permeability.

4. The meter, according to claim number 1, characterized because the electronic and communication blocks are powered from a power source consisting of at least one long-life battery.

5. The meter, according to claim number 1, characterized because the register and the electronic blocks and the transmitter sub-block of the communication block are housed in the casing made of a suitable material to keep these components isolated from moisture and of the entry of water besides providing a free of corrosion coverage.

6. The meter, according to claim number 1, characterized because the microprocessor digitizes, averages and stores in memory the received flow data and after a predetermined time sends them to the display and whose microprocessor which has a connection and communication command with the transmitter sub-block allowing the remote transmission of accumulated data.

7. The meter, according to claim number 1, characterized because the register and the electronic blocks and the transmission sub-block are arranged in measurement site integrated into one unit and the receiver sub-block is mobile and portable.

8. The meter, according to claim number 1, characterized because both the transmitter and receiver sub-sets have the capacity to store commands and data and the transmitter subset has a transmission power with a range of 15 to 20 meters.

9. The meter, according to claim number 1, characterized because the inlet and outlet of the register tube are provided with the appropriate fittings to connect them with the corresponding pipes.
